(19) United States
(12) Patent Application Publication
(10) Pub. No.: US 2023/0323519 A1
(43) Pub. Date: Oct. 12, 2023

(54) FORMATION OF SURFACE OXIDE COATINGS FOR ZIRCONIUM AND ZIRCONIUM BASED ALLOYS

(71) Applicant: Michael T. Clarke, Manlius, NY (US)

(72) Inventor: Michael T. Clarke, Manlius, NY (US)

(21) Appl. No.: 18/132,051

(22) Filed: Apr. 7, 2023

Related U.S. Application Data
(60) Provisional application No. 63/329,649, filed on Apr. 11, 2022.

(51) Int. Cl. C22F 1/18; C22C 16/00; C01G 25/02

(52) U.S. Cl. CPC C22F 1/186; C22C 16/00; C01G 25/02

(57) ABSTRACT

A process for forming a durable, resistant oxide coating on zirconium metal or zirconium-based alloys, in which the metal or alloy is heated either rapidly to a predetermined temperature in an oxidizing or non-oxidizing environment or heated rapidly or slowly in an environment substantially devoid of an oxidizing agent until the predetermined temperature has been reached. The base metal can be pure zirconium or a zirconium-based alloy having niobium and/or titanium. The temperature, oxygen level, and time of exposure are controlled to elicit the desired properties. The oxidized specimen is then cooled under controlled conditions to further control the thickness and hardness of the oxide layer.

### CROSS REFERENCE TO RELATED APPLICATION

This application claims priority under 35 U.S.C. § 119 and 35 U.S.C. § 120 to U.S. Patent Application Ser. No. 63/329,649, entitled: Formation of Surface Oxide Coatings for Zirconium and Zirconium Based Alloys, filed Apr. 11, 2022, the foregoing application being incorporated by reference herein in its entirety.

### TECHNICAL FIELD

This invention generally relates to a thermal oxidation process for producing durable wear-resistant oxide or oxide-like coatings on zirconium metal or zirconium based metal alloys. More specifically, this invention relates to an inventive process for producing improved blue, blue-black, or grey-blue zirconium oxide coatings that can be tailored for components of varied shapes for use in a number of different applications and environments.

### BACKGROUND

Zirconium is an excellent material choice for a number of varied components covering different fields of use given its overall resistance to corrosion. For example, zirconium's resistance to corrosion by hot water enables its use as a fuel-cladding material in boiling-water and pressurized-water nuclear power reactors. Zirconium alloys have also seen expanded applications in the medical device field for use in surgical implants, such as orthopedic (i.e., knee, hip) replacements. However and in spite of its corrosion resistant characteristics, zirconium also has a relatively low resistance to abrasion as well as a tendency to gall, which is due in part to its relatively low hardness.

To increase their abrasion resistance, considerable efforts have been made in the prior art to produce zirconium oxide (zirconia) coatings on various zirconium and zirconium alloy shapes. For example, there are known processes for producing blue-black zirconium oxide coatings using air, water or steam oxidation. According to yet another known technique, zirconium alloy substrates can be treated with molten salts, such as sodium cyanide and combinations of sodium chloride and potassium chloride each containing various oxidizing compounds. Historically, each of these previously known oxide forming processes typically are performed at a temperature regime between 400° C. and 800° C. and form useful oxides that are relatively thin (<20 microns). Attempts to provide thicker oxides using existing methods result in oxides that are prone to pores and/or cracks that limit their usefulness.

To provide a suitable oxide coating for many applications, the oxide surface must have sufficient adherence to the base metal, also referred to throughout this disclosure as the “base alloy” and/or the “substrate”. Additionally and depending on the particular application or use, the oxide should not permit the inclusion of pores or cracks, which weakens the overall integrity of the formed oxide coating. Also depending on the shape of the oxidized component, there would preferentially be a tendency not to form significant cracks on corners or curves of the components. This is a concern for a thermally dependent oxidation process, as during cooling, the hard and more brittle zirconium oxide surface has a different coefficient of thermal expansion than that of zirconium metal or zirconium alloys, which are typically tougher and more ductile. Still further, a thick oxide coating with high hardness and elastic modulus overlying a thin oxygen enriched metal interface transition to the base metal is desirable so that there is a gradual rather than an abrupt change in mechanical properties, including elastic modulus. Additionally, it is preferred that a majority of the higher ductility and toughness of the substrate is retained, while improving the surface hardness and wear characteristics.

Accordingly, there is a prevailing need in the field to provide a durable, resistant oxide coating that can be made thicker than those available using the existing art and an oxide forming process for zirconium and zirconium based alloys for a range of applications and shapes of components.

### General Description

The present invention is specifically directed to the above-noted issues. In accordance with one aspect of the present invention, there is described a process for forming an oxide coating on zirconium metal or zirconium-based alloys. The process comprises the steps of heating the metal or alloy in a furnace either rapidly to a predetermined temperature in an oxidizing or non-oxidizing environment, or heating the metal or alloy either rapidly or more slowly to a predetermined temperature in an environment that is substantially devoid of an oxidizing agent until the predetermined temperature has been reached. According to at least one embodiment, the predetermined temperature is at least 800° C., but more preferably at least 900° C., and still more preferably at least 1000° C.

In at least one version, the oxidizing agent is oxygen in which the process further comprises the step of heating the metal or alloy under vacuum or in the presence of an inert gas until the predetermined temperature has been reached.

The zirconium-based alloy can include at least one of niobium and titanium as alloying elements. In one version, the zirconium-based alloy can contain at least 10 percent niobium by weight. In another version, the zirconium-based alloy can contain at least 20 percent niobium by weight, and according to yet another version can contain about 40 percent niobium by weight.

In at least one version, the zirconium-based alloy can include no more than 15 percent titanium by weight. In another version, the zirconium-based alloy can include about 5 percent titanium by weight. One preferred alloy that produces a suitable oxide coating in accordance with the present invention contains 55 percent zirconium by weight, 40 percent niobium by weight and 5 percent titanium by weight. Another preferred alloy that produces a suitable oxide coating in accordance with the present invention contains 75 percent zirconium by weight, 20 percent niobium by weight and 5 percent titanium by weight.

The oxidizing agent used in the inventive process is preferably oxygen in which the process further comprises the step of heating the metal or alloy under vacuum or inert gas until the predetermined temperature is reached. However, the herein described process can also be conducted using other oxidizing agents or environments such as but not limited to air, water or steam oxidation, among others.

The oxide forming process further comprises a cooling step in which the cooling is preferably conducted in the presence of an oxidizing agent. In at least one version, the oxidizing agent is oxygen. The process further comprises controlling the partial pressure of the oxygen, the temperature, and time of exposure thereof, in order to adjust the thickness and hardness of the formed oxide. Other alloying elements can be used, wherein the zirconium whether metal or alloy can include hafnium.

According to another aspect of the invention, there is described an oxide coating for a zirconium metal or a zirconium-based alloy made by the process in which the zirconium metal or a zirconium-based alloy is either one of rapid heating in a furnace to a predetermined temperature in an oxidizing or non-oxidizing environment, or slow heating in the furnace which is substantially devoid of an oxidizing agent until the furnace has reached the predetermined temperature. According to at least one version, the predetermined temperature is at least 800° C., more preferably at least 900° C., and still more preferably at least 1000° C.

Preferably, the zirconium-based alloy can include predetermined amounts of niobium and/or titanium as alloying elements. One preferred alloy contains 55 percent zirconium by weight, 40 percent niobium by weight and 5 percent titanium by weight. Coating thicknesses of the resulting oxide coating can be controlled by varying the partial pressure of oxygen or other oxidizing agent and exposure time during both the maximum temperature and cooling phase of the process.

According to yet another aspect of the invention, there is provided a system for producing an oxide coating for zirconium metal or a zirconium based alloy comprising a furnace with a vacuum pump or pumps (e.g. mechanical, diffusion, turbomolecular) to control the partial pressure of an oxidizing gas. The system is configured to maintain a vacuum within the furnace until the hot zone of the furnace has reached a predetermined oxidizing temperature. According to a preferred version, the predetermined temperature is at least 800° C., more preferably at least 900° C., and still more preferably at least 1000° C.

One advantage of the herein described oxide forming process is that a thick, durable, wear resistant oxide coating can be created without corner cracks or cracks in the oxide or oxygen-rich metallic interface extending to the base metal, thereby enabling components of various shapes to be coated.

Another advantage is that the overall thickness of the formed oxide coating can be suitably controlled to permit tailoring of a finished product or component. In addition, the herein described process enables the toughness and hardness of the resulting oxide coating to also be suitably controlled.

Advantageously, the herein described process enables use of zirconium and zirconium-based alloys for more expansive uses in a number of varied fields including but not limited to, bearing surfaces, implant materials, for corrosive environments, as structural members, cookware, cutting tools, armor and cosmetic items.

The above description and explanations and other features and advantages will be readily apparent from the following detailed description, which should be read in conjunction with the accompanying drawings.

### BRIEF DESCRIPTION OF THE DRAWINGS

The accompanying drawings, which are incorporated herein and constitute part of this specification, illustrate presently preferred embodiments of the invention, and together with the general description given above and the detailed description given below, serve to explain features of the invention (in which like reference numerals represent like elements or steps) of which:

FIGS. 1(a)-1(c) depict photographs, taken under various magnifications, of a portion of an oxide coating surface made in accordance with prior art processes;

FIGS. 2(a)-2(d) depict photographs, taken under various magnifications, of a portion of another oxide coating;

FIGS. 3(a)-3(c) depict photographs taken under magnification of a portion of an oxide coating made in accordance with another prior art process;

FIG. 3(d) depicts a representation of a sectioned specimen having (3) discernable layers of oxide, oxide enriched metal and base alloy;

FIG. 4 is a photograph of a specimen subject to 3 point bending taken under magnification, depicting a deep crack;

FIG. 5 is a photograph of a specimen subject to 3 point bending taken under magnification, depicting a shallower crack than FIG. 4;

FIG. 6 is a less magnified photograph of the specimen from FIG. 5 showing multiple shallow cracks after bending;

FIG. 7 is a photograph of a specimen subject to 3 point bending taken under magnification, depicting a crack and delamination of the oxide;

FIG. 8 is a less magnified photograph of the specimen from FIG. 7 showing multiple shallow cracks after bending;

FIG. 9 is a flow chart of an exemplary process in accordance with aspects of the present invention;

FIG. 10 is a graphical representation of hardness of a formed oxide coating versus distance from the surface in accordance with an embodiment of the present invention;

FIG. 11 is a graphical representation of hardness of a formed oxide coating versus distance (thickness) in accordance with another embodiment of the present invention;

FIG. 12 is a graphical representation of hardness of a formed oxide coating versus distance (thickness) in accordance with yet another embodiment of the present invention;

FIG. 13 is a graphical representation of hardness of a formed oxide coating versus distance from the surface in accordance with yet another embodiment of the present invention; and

FIG. 14 is a graphical representation of specimens made in accordance with aspects of the present invention, depicting relationships between temperature of oxidation, oxide thickness, and resultant crack depth to oxide thickness (C/O) ratio.

### DETAILED DESCRIPTION

The following detailed description should be read in reference to the drawings, in which like elements in different drawings may be identically numbered. The drawings, which are not necessarily to scale, depict selected or exemplary embodiments and are not limited to the scope of the invention. The detailed description, which follows, illustrates by way of example, not by way of limitation, the principles of the present invention. This description will enable one skilled in the art to make and use the invention and describes several embodiments, adaptations, variations, alternatives, and uses of the invention, including what is believed to be the best mode of carrying out the invention.

As used herein, the terms “about” or “approximately” for numerical values or ranges indicate a suitable dimensional tolerance that follows the component, parts or collections of components in order to function for the intended purpose as described herein, including various temperature ranges, thicknesses, and process parameters, in addition to various weight percentages of various constituent components. More specifically, “about” or “approximately” may refer to the range of values ±15 percent of the recited value, e.g., “about 800° C.” may refer to the range of values from 680 to 920 degrees Celsius.

In addition, and as used herein the terms “oxide”, “oxide coating”, “oxide-like coating”, “oxide-like layer”, and “oxide layer” are herein used synonymously to define the formed layer produced or created by the herein defined oxidation process. To that end, the formed layer may include both oxide and non-oxide materials of the constituent alloying elements.

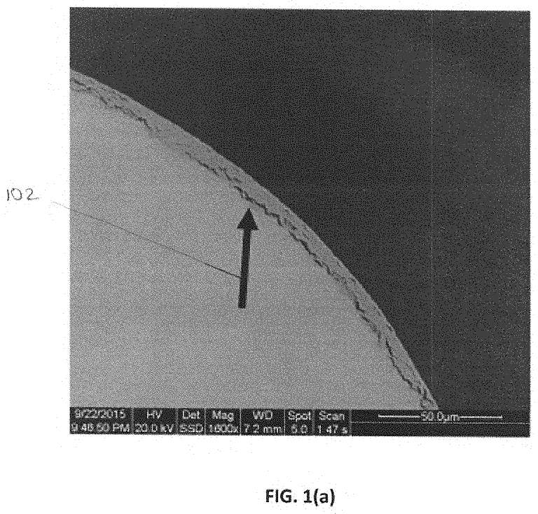

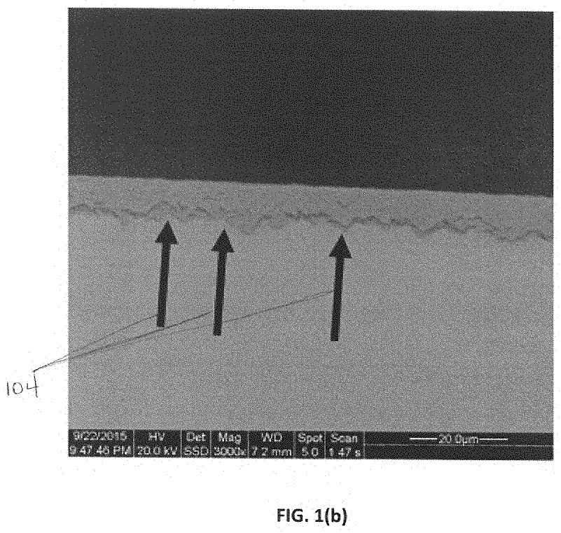

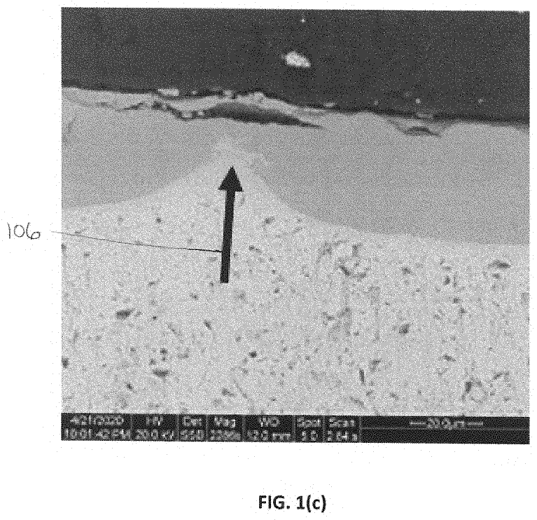

A fundamental aspect first discussed herein by Applicants is the phenomenon of heating of zirconium or zirconium based alloys below 800° C. in an oxidizing atmosphere or environment that invariably creates oxides with pores in the formed oxide coating layer if the oxide thickness is desired to be greater than about 20 microns. This effect is clearly shown by electron microscopy as illustrated in the microphotographs presented as FIGS. 1(a)-1(c) under different magnifications, each depicting a portion of a pure zirconium metal sample that has been oxidized at a temperature below 800° C.; see arrows 102, 104, 106, each highlighting various formed pores in the formed coating layer. The presence of these pores is undesirable with regard to the overall integrity of the formed component. The formed oxide layers are also cracked and irregular in terms of their overall thickness. Moreover, though the sample shown in FIGS. 1(a), (b), and (c) is that of zirconium metal, it should be noted that the addition of any other alloying element under the same processing conditions will also similarly produce pores in the formed oxide layer as depicted.

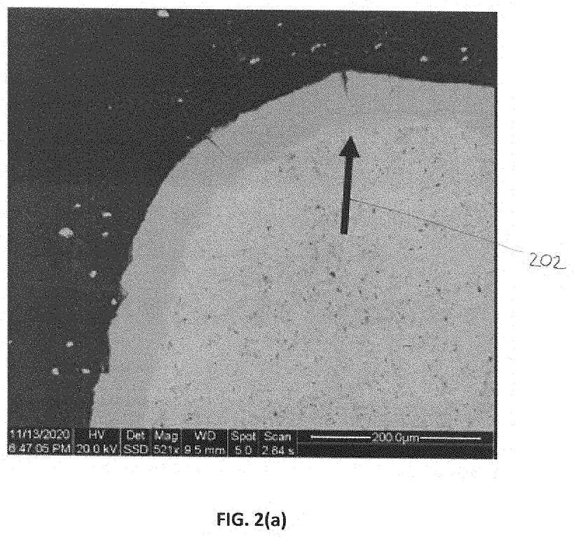

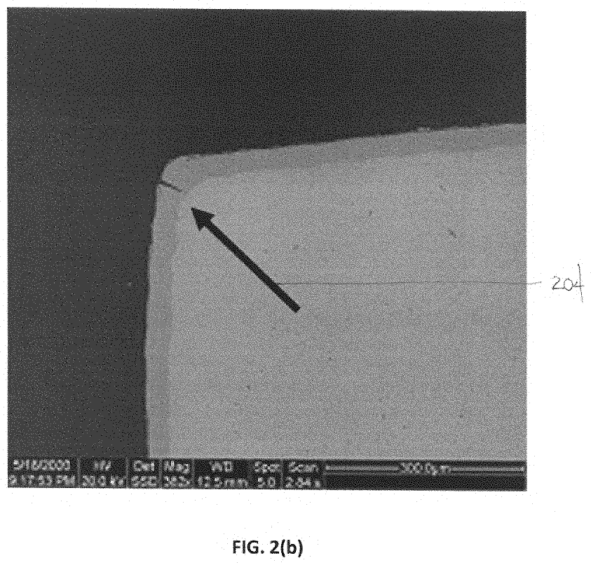

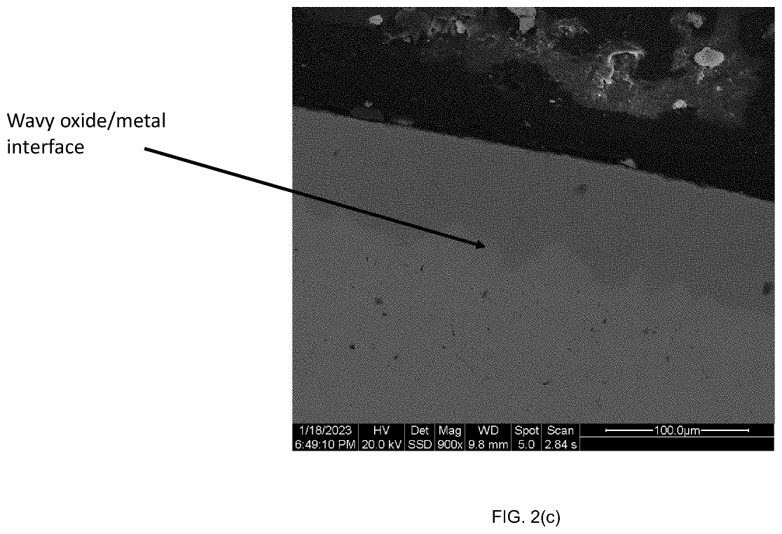

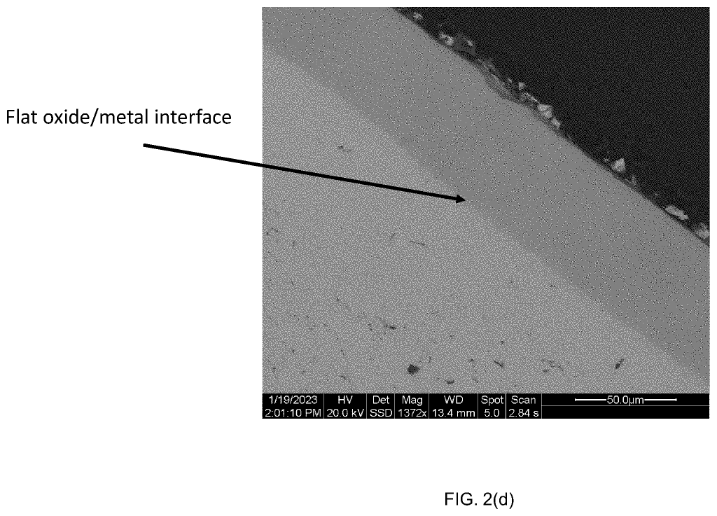

Heating above 800° C., but below 900° C. in an oxidizing environment on zirconium or zirconium based alloys produces oxides that have good flat surface characteristics, but the resulting oxide coatings also contain corner cracks, suggesting residual stress which is also less than desirable, particularly when component shapes have curves, corners or edges. This particular cracking effect is clearly depicted in the electron microscope photographs provided in FIGS. 2(a) and 2(b); see arrows 202, 204 for an alloy specimen of 75Zr20Nb5Ti (the noted amounts based on weight percentages).

It should be noted that the effects of slow cooling after heating does not prevent corner cracking as shown in FIGS. 2(a) and 2(b) from occurring. In addition, it has been further shown that slow cooling of formed oxide coatings, without otherwise controlling the partial pressure of the oxidizing environment allows oxygen to penetrate more deeply into the substrate as the diffusion of oxygen into the formed oxide layer, is both temperature and time dependent. This penetration is unnecessary and may even be undesirable, depending upon the intended use of the oxide coating layer. As the cooling rate is slowed, greater time is allowed for thermally driven reactions to occur between oxygen and the metallic substrate at temperatures lower than the desired temperature. This results in the interface between the oxide and metallic substrate becoming irregular, which may impart undesirable interfacial stresses that can lead to delamination of the oxide surface, as shown by way of example in FIG. 2(c). As described in greater detail herein, a more rapid cooling process allows for a more even and planar metal-oxide interface, potentially minimizing interfacial stress and the risk of oxide delamination, as shown in FIG. 2(d). Moreover, it has also been demonstrated that the addition of alloying metals, such as niobium and/or titanium, does not substantially prevent oxygen diffusion into the substrate, and therefore the foregoing effects, from occurring.

Applicants have determined that the heating of pure zirconium or zirconium based alloys above 900° C. in an oxidizing environment can provide oxide coatings that are substantially pore and crack free. More preferably, heating above 1000° C. has been determined to be more reliable in providing each of these desirable effects. As discussed herein, heating of a zirconium or zirconium-based alloy component/substrate can be achieved through rapid heating of the component/substrate to the appropriate temperature (at least 800° C.) in either an oxidizing or non-oxidizing environment. This can be achieved, for example, by placing the metal or alloy directly in a pre-heated furnace. Optimally, however, the heating should occur slowly or rapidly in the absence of a substantial oxidizing environment (e.g., in inert gas or vacuum etc.) until the substrate/component has actually reached the predetermined temperature for oxidation.

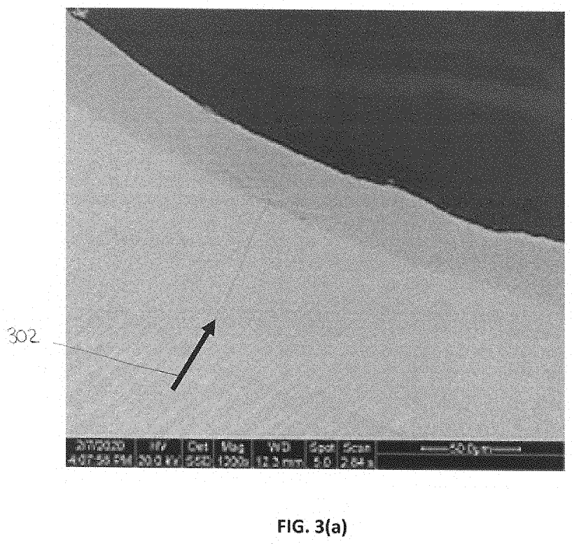

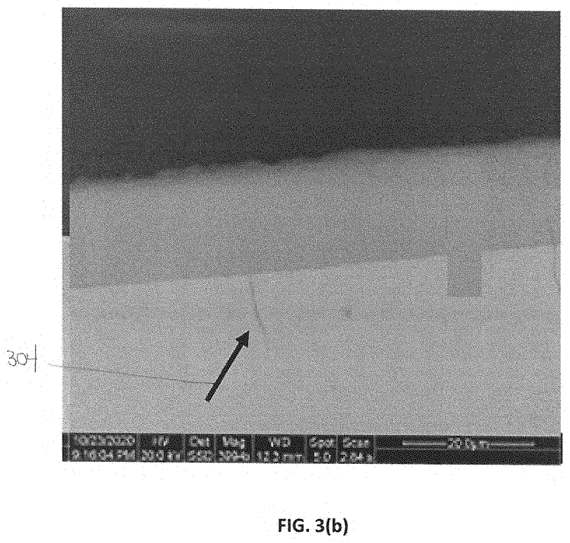

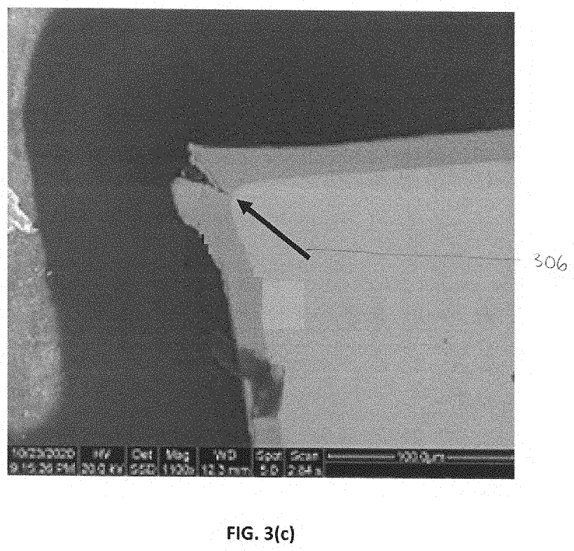

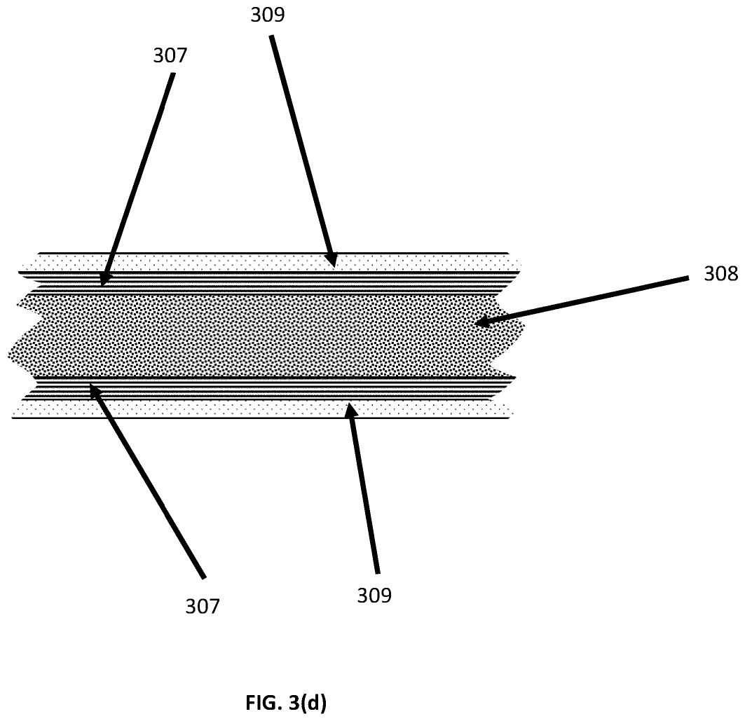

Oxidation of zirconium and its alloys as described herein results in at least 3 distinct layers from the surface inwards as detailed in FIG. 3(d), which represents a not-to-scale drawing of a sectioned 5 mm thick plate of oxidized zirconium. More specifically, there is an outer oxide layer 309, an innermost unoxidized metal core 308, and an oxygen enriched but relatively brittle metallic transitional interface layer 307. Zirconium alone can be oxidized in the manner described, but the resultant oxide coating or coating layer is not optimal, as (1) cracks in the brittle oxygen enriched transitional interface layer 307 created between the outer oxide layer and the base metal form during cooling, and (2) the oxide 309 is subject or prone to cracking during cooling, particularly on areas of residual stress such as corners, edges or radii. This latter effect is illustrated by way of example in FIGS. 3(a)-3(c), each depicting specimens of pure zirconium that have been oxidized at 1000° C. With reference to each of these figures, cracks are clearly shown in the transition zone, see arrows 302, 304, and at the corner of the formed oxide coating, see arrow 306. Additionally, the use of pure zirconium for oxide formation without inclusion of any alloying elements also creates a relatively high crack depth to oxide thickness (C/O) ratio, herein defined as the measured depth of the crack from the surface of the oxide relative to the measured depth of the oxide coating layer itself when subject to 3 point bending to an angle of 45 degrees in a 5 mm thick specimen. The C/O ratio is a measure of the ductility of the surface layers and an indirect measure of the depth of penetration of oxygen into the metal alloy after oxidation. Low C/O ratios are considered desirable for many applications as a low ratio indicates shallow penetration of oxygen into the substrate and/or ductility of the base alloy crystal structure in the presence of differing levels of dissolved oxygen. Unoxidized zirconium and its alloys useful for oxidation are typically highly ductile and will not exhibit cracking during the same bending test.

Therefore heating a zirconium component/substrate at a sufficiently high temperature in an oxidizing environment, though providing benefits, is not itself sufficient to creating an optimal oxide coating. The inclusion of alloying elements may be preferred, depending on the specific application or intended use of the component. Of particular note for the process herein described, niobium and titanium are described for use herein. Other alloying elements can be contemplated.

The inclusion of niobium as part of a zirconium based alloy helps to eliminate the incidence of cracks on corners as well as within the interface transitioned between the outer oxide layer and the base metal. For example, with the inclusion of about 15% niobium by weight, cracks in the corners of the formed oxide layer as well as the interface are rare. With an increased inclusion to about 20% niobium by weight, corner cracks are virtually eliminated.

A low C/O ratio is desirable for many applications, but especially in those instances in which relatively thin components are to be made, where the ductility and toughness of the base alloy needs to be minimally compromised by embrittlement from oxidation. The addition of small amounts of niobium initially increases the C/O ratio but then as the percentage of niobium increases the C/O ratio starts to decrease. It has been determined empirically that decreases in the C/O ratio begin at about 20% niobium by weight (titanium and oxygen content are unchanged). It has also been demonstrated that as the amount of niobium in the alloy is increased within a range of 2.5% to 50%, the oxygen mass gain per unit surface area during the same experimental conditions is reduced. This inhibition of oxygen absorption into the alloy and/or the enhanced ductility provided by the increasing amounts of niobium is helpful in keeping the C/O ratio low. The amount of niobium to be usefully added to the zirconium-based alloy is limited in that the diffusion of oxygen embrittles the base alloy or metal significantly reducing its overall ductility and toughness which may cause the base alloy to crack under applied forces, particularly those applications that are subject to cyclical stresses and failure due to crack propagation. This cracking would effectively render the component useless specifically in applications or uses encountering cyclic loads, such as surgical implants. It has been further determined empirically that the effect on the C/O ratio is maximal at about 40% niobium content by weight, but higher levels of niobium in the alloy will still reduce the undesirable presence of cracks.

Applicants have determined that the amount of oxygen in the base alloy prior to oxidation has a significant effect on its crystalline and mechanical properties, depending on the rate of cooling from high temperatures. Zirconium and zirconium alloys are commonly produced commercially with oxygen contents typically ranging from 200 ppm (0.02% by weight) to 2000 ppm (0.2%). Producing alloys with contents lower than 300 ppm can be expensive and therefore not commercially viable. Accordingly, and so the process of oxidation to create an oxide layer, as described herein, must also take into account the pre-existing oxygen level. Metallurgically, oxygen is an α phase stabilizer, whereas niobium is a β phase stabilizer. The degree of α and β phases in the alloy has a significant effect on its mechanical properties. By way of example, if an alloy of 55% zirconium, 40% niobium, 5% titanium and 400 ppm oxygen is heated above the eutectoid (circa 850° C.) where a solid solution is present and cooled either slowly (<50° C. per minute) or rapidly (>50° C. per minute) to below the point where the solid solution separates into two isomorphic body-centered cubic (BCC) β phases and then lower further to below the transus temperature where allotropic transformation of the β-Zr starts to form hexagonal close-packed (HCP) α-Zr (circa 610° C.), the base alloy retains ductility and can be plastically deformed without cracking at room temperature. As the oxygen content in the same alloy is increased, the rate of cooling alters the mechanical properties as well as the temperature at which the transus and eutectoid changes occur. For the same alloy of 55% zirconium, 40% niobium, and 5% titanium with 800 ppm oxygen content cooled at 10° C. per minute, the oxide surface and the base alloy exhibits significant surface cracks under the same mechanical deformation with a high C/O ratio. With over 1000 ppm oxygen content the alloy is highly brittle and will catastrophically fail. If the same alloys are cooled rapidly, such as with an air or oil quench for example, the ductility is retained and the C/O ratio is low. This latter effect is likely related to the restricted formation of α-Zr phases and/or the formation of metastable crystalline phases known to exist in other zirconium alloys such as α′, ω and metastable β. In this manner, and as is known in the field, the mechanical properties of the final product can be tailored to suit the intended application.

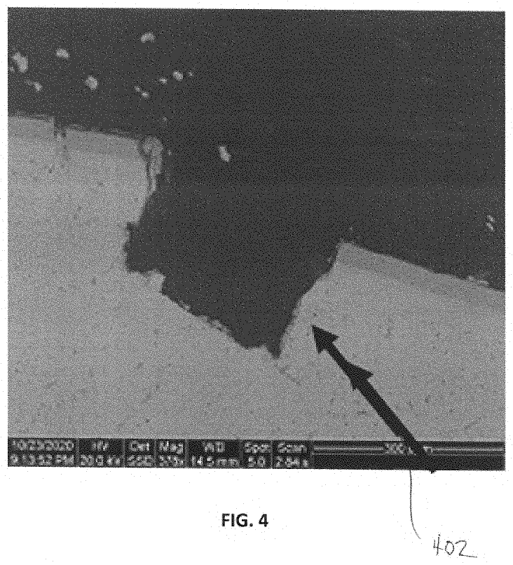

In support of the foregoing and as shown in FIG. 4, a photograph is provided under high magnification illustrating a deep crack 402 that is formed in a bent zirconium based alloy specimen having 20% niobium (by weight). The crack 402 has a depth that is about 10 times the oxide depth. Therefore, the C/O ratio=10.

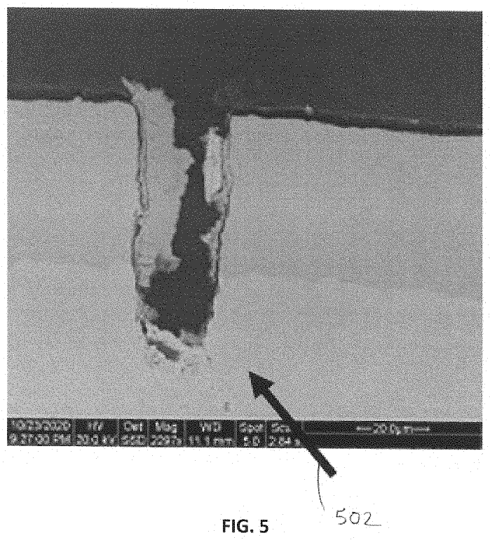

By way of comparison and as shown in FIG. 5 (more magnified that that of FIG. 4) a shallow crack 502 is formed in a bent zirconium alloy specimen containing 40% niobium (by weight) the oxide layer being formed under the same processing conditions for purposes of comparison. In this latter example, the formed crack through and below the oxide layer 502 is about 0.5 times the depth of the formed oxide layer. Therefore, the C/O ratio=1.5.

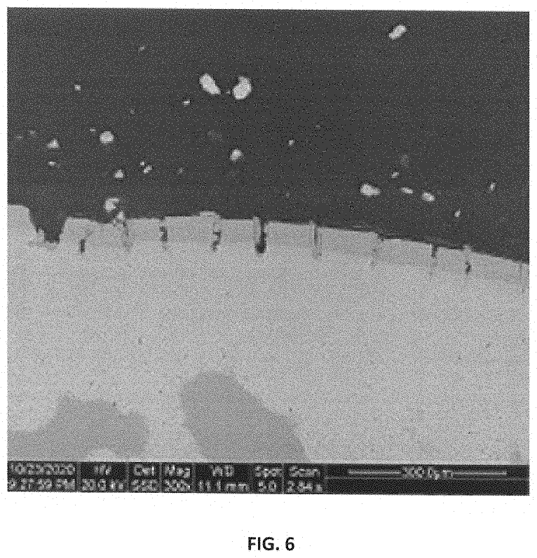

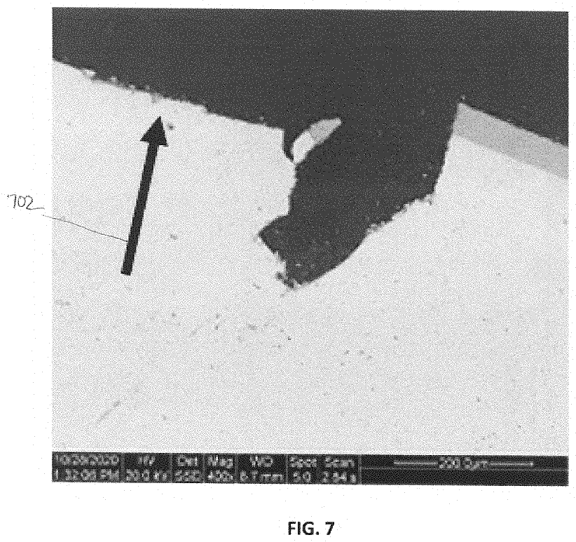

A further beneficial effect created by the addition of niobium to a zirconium-based alloy is that the formed oxide or oxide-like coating tends to remain more tenaciously attached to the base metal than those alloys in which niobium is not included. By way of example and as shown in FIG. 6, an oxide coating is depicted which is still attached to the base metal after bending to 45 degrees. This zirconium alloy specimen contains 40% niobium, by weight. Contrasting, and as shown in FIG. 7, and under similar conditions, an oxide coating containing 20% niobium by weight is partially delaminated from the base metal, as shown on the left side of image; see arrow 702 in a bent specimen.

Another alloying element that provides advantageous effects in terms of oxidizing a zirconium based alloy is titanium. The use of titanium enhances the penetration (diffusion) of the oxygen into the metal even at very low percentages (<1%). The use of titanium also has the effect of modifying the C/O ratio. In accordance with the herein described forming process, it has been determined that this modifying effect is optimal at about 5% titanium by weight. At higher percentages (>10% by weight), the inclusion of titanium tends to make the formed oxide coating considerably more brittle and also more prone to lose adherence and delaminate from the base metal.

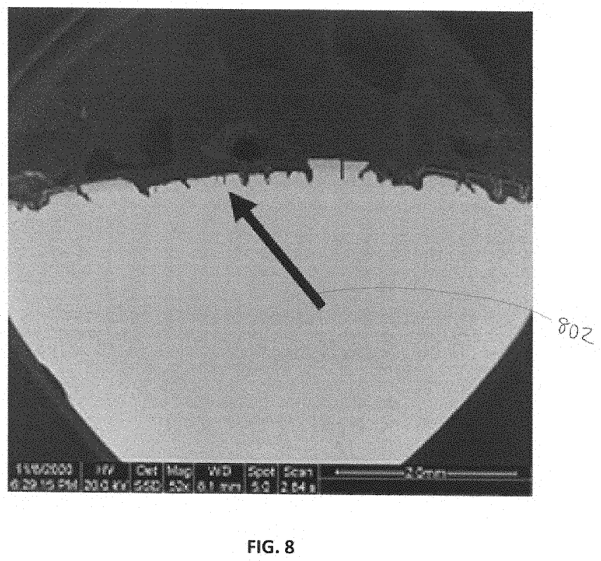

In support and as shown in the high magnification photograph at FIG. 8, a formed oxide coating of a zirconium-based alloy sample having about 20 percent of titanium, by weight is shown, in which the formed oxide layer has actually delaminated from the base metal after bending; see arrow 802.

Hence the C/O ratio is able to modified by several factors including the amount of niobium, titanium and oxygen in the alloy, as well as the rate of cooling.

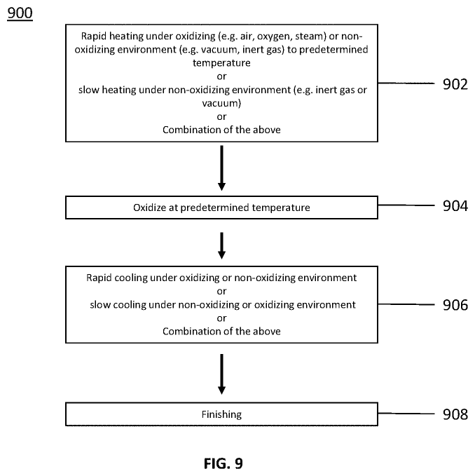

Reference is herein made to FIG. 9, which depicts a flow chart of an exemplary oxide forming process 900 in accordance with aspects of the present invention. More specifically, and in accordance with a first step 902 of the herein described process 900, zirconium or more desirably, alloys of zirconium are heated in a furnace in a manner that prevents (or at least minimizes) oxidation below 800° C. Known oxide forming processes specifically require oxidation only at lower temperatures resulting in thicker oxide coatings with pores. In addition, these known processes result in the creation of much thinner oxide layers than those that can be produced in accordance with the present invention. According to the inventive process herein, high temperature oxidation can be achieved either by: i) relatively rapid heating in an oxidizing or non-oxidizing environment to the desired temperature such that oxidation during the ramp up phase heating is limited, or more desirably ii) through more slowly and controlled heating in an environment that is substantially devoid of an oxidizing agent (e.g., inert gas or vacuum) to a predetermined temperature for oxidation. More specifically, the predetermined temperature is above 800° C., more preferably above 900° C., and even more preferably above 1000° C. Oxidation then occurs, step 904 at the predetermined temperature following the initial heating step 902.

The rapid heating steps of the described process herein can be conducted in any oxidizing or non-oxidizing environment, but the slower steps preferably are conducted via vacuum or inert gas, where partial pressure can be controlled fairly precisely.

Zirconium is highly reactive with oxygen and as a result, pressures as low as 0.01 mbar oxygen can substantially oxidize the specimens during slow heating (0.5° to 50° degrees C. per minute for instance) up to 800° C., resulting in an oxide coating that is replete with undesirable cracks and/or pores. Conversely and in accordance with the present invention, pure zirconium or zirconium alloy specimens can achieve a satisfactory oxide layer when placed directly in a furnace at 800° C. or higher such that rapid heating occurs in an oxidizing or non-oxidizing environment, but oxidation below 800° C. as the specimen attains the furnace temperature after initial placement, is minimized due to the rapidity of the heating. If a method of heating is chosen such that oxidation below 800° C. does occur, further oxidation above 800° C. is still possible as described herein, but the resultant oxide coating may need further processing (e.g. machining, grinding, polishing, etc.) in order to remove any superficial porous and/or cracked oxide that is created due to the low temperature oxidation exposure.

The alloy chosen, the amount of oxygen present, the time of exposure to oxygen, and the temperature of the reaction are all relevant in determining the thickness, adherence, and character of the resulting formed oxide as well as the oxygen rich metallic interface that bridges the oxide and the base metal. The oxidation process may occur at atmospheric pressure or higher, or desirably, for thinner oxide layers, at a partial pressure of oxygen for easier control of the reaction. The thermokinetics of the reaction are such that the rate of the reaction is dependent on the amount of oxygen present, but is saturated well below atmospheric pressure. If a particular thickness of oxide is desired, the sample can be exposed to a specific partial pressure or rate of flow of oxygen for a specific time and at a specific temperature. The oxygen pressure need not be constant at the reaction temperature or during cooling. Cooling under an oxidizing environment is not as deleterious to the integrity of the oxide (unlike during heating) however, as an oxide surface has already formed and is not significantly affected by further oxidation below 800° C. unless the exposure time is prolonged.

Following the heating steps, a subsequent cooling phase (see step 906, FIG. 9) of the process can be relatively slow and preferably controlled according to at least one embodiment. Alternatively, the cooling can be rapid in duration and may further include quenching such as can be performed, for example, using oil, water, or liquid nitrogen. The speed of cooling has been demonstrated to affect the mechanical properties of the base alloy as mentioned above, particularly when the amount of dissolved oxygen is taken into account. These control parameters can be varied for tailoring results. For example, a certain mass, partial pressure or flow rate of oxygen is allowed in a controlled atmosphere or vacuum furnace and as the oxygen is consumed by the reaction, a pressure decrease occurs. This pressure decrease typically occurs in a non-linear fashion with the drop in pressure being rapid at first and then occurring more slowly thereafter. This is because oxygen takes longer to diffuse more deeply into the metal through the already formed oxide in order to react. The amount of oxygen present for reactivity is determined by the volume of the furnace Tillable with gas (e.g., oxygen or co-present inert or non-inert gas) and the surface area of reactive elements. For example, a large furnace having a substantial volume for gas containing a low surface area of zirconium reactant will clearly have a lower pressure drop as the reaction proceeds than will a smaller furnace with a large reactive surface area of oxidizable material. Alternatively, and more desirably, the pressure can be held constant by a feedback loop (not shown), so that new oxidizing agent can be allowed into the chamber of the furnace as the agent (oxygen) is being consumed by the reaction. It should be noted that different furnace designs may require different parameters, depending upon what the hot zone constituents are made from and the relative reactivity or passivity of the hot zone to the presence of oxygen.

The overall process may preferably include a subsequent finishing process, see step 908, FIG. 9, to attain the desired surface finish and dimension. During heating and oxidation, the materials undergo dimensional and surface roughness changes. This dimensional change is generally related to the thickness of the formed surface oxide. Surface roughness is usually increased after oxidation. These changes to dimension and surface roughness are consistent and can be accounted for when preparing specimens for the herein described oxidation process. The final product specifications may necessarily include removing material from the oxidized surface (e.g. machining, grinding, polishing etc.) in order to achieve a desired dimensional and surface finish tolerance. Accordingly, and if sufficient material is removed, the surface hardness of the deeper layer will be lower than if unfinished after heating as described elsewhere in this application and attached figures.

The resulting surface oxide formed in accordance with the herein described process is dark blue, grey-blue, or black-blue in color depending upon the amount of niobium or other alloying element chosen and may be a ceramic, a ceramic-like material, a metal-matrix composite, or a combination thereof with a partially or fully oxidized surface. Utilizing the correct processing parameters and alloy combinations, a thick, hard, wear resistant, impact resistant and delamination resistant, chemically stable, tenaciously attached oxide surface that is pore and crack free can be created. The formed oxide surface may be fully or partially ceramicized or may have substoichiometric oxide combinations, e.g., ZrO₂, Zr(O)n, Nb₂O₅, NbO, NbO₂, Nb(O)n TiO₂, TiO, Ti₂O₃, Ti(O)n or unoxidized metal where (n) may be an integer of a fraction for each of the examples above.

As noted, the outer oxide surface is transitioned to the base metal by an oxygen rich, diffusion-hardened metallic interface. When made in accordance with the process described herein and as further discussed in the following working example and figures, the interface preferably transitions in terms of hardness as the base metal is approached from the surface of the oxide.

Working Example: A Sentrotech STV-666 air/inert gas/vacuum furnace was used in which a zirconium based alloy was introduced and in which the furnace had been additionally modified for high vacuum (<10⁻⁵ mbar) by the addition of a side or otherwise welded diffusion pump. According to this specific example, the zirconium based alloy sample used was a 55Zr40Nb5Ti (by weight percentage) with 300 ppm oxygen content, 5 mm thick by 10 mm wide by 30 mm long plate. The sample was supported by and separated from the floor of the ceramic hot zone of the furnace by two (2) 5 mm by 5 mm by 1 mm graphite shims and then heated in a vacuum <0.001 mbar at a rate of 20° C. per minute and then exposed to a maximal pressure of oxygen of 1.5 mbar for a period of 30 seconds at a temperature of 1050° C. after a 30 second hold. The resulting oxide or oxide-like coating had a thickness of approximately 80 microns. The pressure was kept constant at 1.5 mbar in this specific example during cooling at a rate of 10° C. per minute. In this example, the test alloy required separation from the alumina/silica ceramic insulation of the furnace, as at the temperature used for the time required, has been found to be reactive, resulting in damage to both the test alloy and insulation. This reaction yields undesirable and unpredictable results. Graphite as a supporting material is non-reactive to both test specimens and insulating material, but is also gradually consumed by the presence of oxygen at such temperatures. An alternate supporting material to graphite used was the test alloy itself with an oxidized surface previously created as described above. An advantage of using the already oxidized test alloy as the supporting material is that further oxidation is limited as the oxide is stable on the alloy surface and thus protective to further oxidation unlike graphite, which is continually consumed as the reaction creates gaseous oxides of carbon which diffuse away leaving exposed carbon for further oxidation.

Utilizing the identical process parameters as above (that is, heating a substrate of the same 55Zr40Nb5Ti alloy in a vacuum <0.001 mbar at a rate of 20° C. per minute), but then exposing the substrate to a maximal pressure of oxygen of 2.0 mbar for a period of 30 seconds at a temperature of 1050° C. after a 30 second hold produced an oxide thickness of about 85 microns. Similar changes in oxide layer thickness can be created. For example, the same process parameters as above with 3.0 mbar oxygen pressure produced an oxide thickness of about 90 microns. The same protocol above with 6.0 mbar oxygen pressure produced an oxide thickness of about 95 microns. The same protocol above, but with a 10 minute hold at 1050° C. under 0.1 mbar oxygen pressure produced an oxide thickness of about 100 microns. The cooling can occur in the presence of substantial amounts of oxygen (e.g. atmospheric) below 800° C. without adversely affecting the oxide (as opposed to heating) or the formed oxide can be cooled in an atmosphere substantially devoid of oxygen as during the heating phase. However, a significant oxygen pressure and prolonged cooling at higher temperatures below 800° C. will create a brittle white oxide surface that is prone to delaminating and cracking unlike the dark blue oxide coating layer formed in accordance with the present invention.

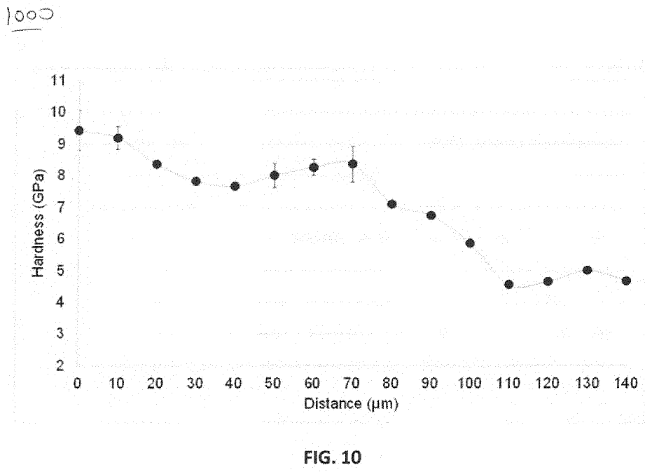

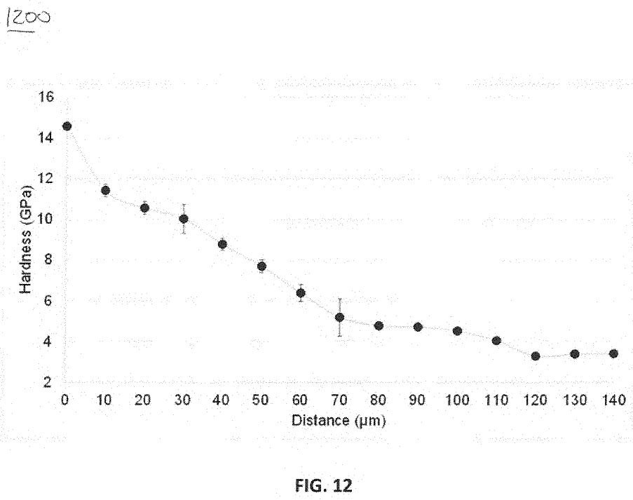

Alternatively, rapid or slow heating and oxidation can be followed by cooling in an atmosphere that is substantially devoid of oxygen. However, cooling in the presence of an oxidizing species is generally more desirable as it creates an oxide layer that is harder, presumably due to the increased oxygenation that occurs. This difference can be comparatively seen in FIGS. 10 and 12 in which the surface hardnesses are 9.5 GPa and 14.5 GPa, respectively, for the same starting alloy where the only processing change was that the sample of FIG. 10 was cooled under vacuum and the sample of FIG. 12 was cooled under an oxidizing atmosphere.

The oxide, while identifiable by standard microscopic techniques, is visually distinct from the base alloy but is not a heterogenous entity. That is, the surface of the resulting oxide coating is harder and becomes softer as the coating approaches the substrate (see FIGS. 10 and 12). The gradual decrease in hardness is likely a reflection of the higher degree of oxidation of the metallic elements at the surface creating a hard oxide species, as opposed to deeper within the oxide where oxygen diffusion and oxygen availability is more limited and oxidation of the elements may be incomplete. By controlling the oxidation process during heating and cooling as indicated above, the oxide from surface to base can be tailored to be harder or softer as the end use demands. Additionally as zirconium oxides are typically harder than niobium oxides, another method of controlling hardness of the oxide would be the choice of base alloy composition.

In another working example using the same furnace, the zirconium based alloy sample used was a 5 mm thick by 10 mm wide by 30 mm long plate of 55Zr40Nb5Ti (by weight percentage) with 300 ppm oxygen content. The sample was again supported by and separated from the floor of the ceramic hot zone of the furnace by two (2) 5 mm by 5 mm by 1 mm graphite shims and heated in a vacuum <0.001 mbar at a rate of 20° C. per minute and then exposed to a maximal pressure of oxygen of 0.1 mbar for a period of 10 minutes at a temperature of 1050° C. after a 30 second hold. The resulting oxide coating had a thickness of approximately 110 microns. The pressure was kept constant at 0.1 mbar in this specific example during cooling at 10° C. per minute.

In another working example in the same furnace, the zirconium based alloy sample used was a 5 mm thick by 10 mm wide by 30 mm long plate of 55Zr40Nb5Ti (by weight percentage). The sample was again supported by and separated from the floor of the ceramic hot zone by two (2) 5 mm by 5 mm by 1 mm graphite shims and heated in a vacuum <0.001 mbar at a rate of 20° C. per minute and then exposed to a maximal pressure of oxygen of 0.1 mbar for a period of 10 minutes at a temperature of 1100° C. after a 30 second hold. In this example, the resulting oxide coating had a thickness of approximately 150 microns. The pressure was kept constant at 0.1 mbar in this specific example during cooling at 10° C. per minute.

In another working example using the same furnace, the zirconium based alloy sample used was a 5 mm thick by 10 mm wide by 30 mm long plate of 55Zr40Nb5Ti (by weight percentage). The sample was again supported by and separated from the floor of the ceramic hot zone by two (2) 5 mm by 5 mm by 1 mm graphite shims and heated in a vacuum <0.001 mbar at a rate of 20° C. per minute and then exposed to a maximal pressure of oxygen of 0.1 mbar for a period of 10 minutes at a temperature of 1100° C. after a 30 second hold. The resulting oxide coating had a thickness of approximately 166 microns. The pressure was kept constant at 0.1 mbar in this specific example during cooling at 10° C. per minute.

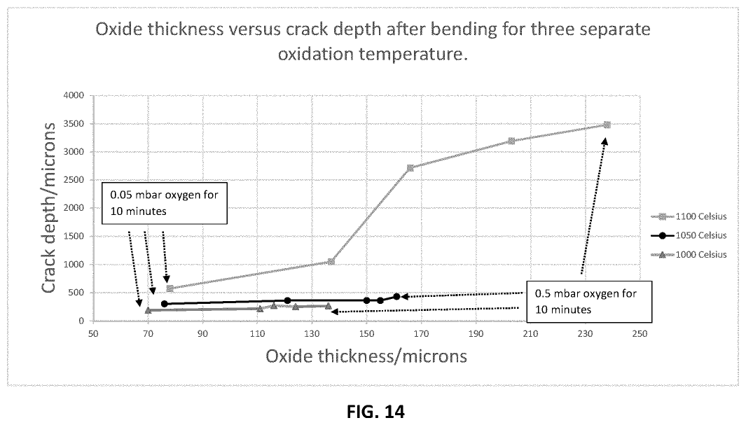

The graph provided in FIG. 14 demonstrates the relationship between temperature of oxidation, oxide thickness and the resultant crack depth to oxide (C/O) ratio in 5 mm thick by 10 mm wide by 30 mm long plate specimens or substrates, each subject to 45 degree 3-point bending. The specimens each had a similar initial oxygen content of about 400 ppm. There are three (3) lines graphically presented in FIG. 14, each line having five (5) data points. More specifically, the lines refer to oxidation of the substrate at either 1050° C., 1100° C. or 1150° C. Each data point represents an oxidation pressure of 0.05 mbar, 0.1 mbar, 0.2 mbar, 0.3 mbar or 0.5 mbar for 10 minutes. At 1050° C., the oxides formed by exposure to oxygen pressures from 0.05 mbar to 0.5 mbar are typically 70 to 140 microns in thickness with C/O ratios between 1 and 3. The oxides, however, start to develop small cracks at corners when approaching 120 microns in thickness. At 1100° C. under the same oxygen levels, the oxide thicknesses are greater (up to 170 microns), but the C/O ratios are higher (up to 8). Corner cracks do not occur until the oxide thickness is over 170 microns. At 1150° C. and under the same oxygen levels, the oxide thicknesses are even greater (up to 240 microns), but the C/O ratios are also even higher (up to 16). Corner cracks were not seen in any of these specimens. It can be envisioned that modifying one or more of the process parameters such as oxygen pressure, exposure time or temperature, even thicker oxides could be created up to and including oxidizing the entire substrate if desired.

If a partial pressure of oxygen is used as the oxidizing source, then the partial pressure of the reaction chamber should preferably be controlled in order to maintain the desired amount of oxygen since the amount of oxygen consumed is dependent on the surface area that is to be oxidized. As oxygen is consumed, the rate of the reaction decreases. Thus, a simple mechanism of valves for maintaining the desired oxygen content can be envisioned regardless of the surface area to be oxidized. Different furnace designs may require different partial pressures, as some of the gas may be non-oxidizing volatiles from the hot zone of the furnace. It is also possible that some furnaces may react with oxygen at the temperatures proposed here and so the exact partial pressure of oxygen required may vary from furnace to furnace. Additionally, certain zirconium alloy combinations have a propensity to react with many refractory agents used as jigs to hold the specimens. Such refractories include but are not limited to alumina, zirconia, silica, magnesia and yttria. If graphite is chosen as a non-reactive refractory to hold the zirconium specimen, then the reaction of the carbon with oxygen must be accounted for. The reaction, forming various oxides (e.g. CO₂, CO), will be dependent on the surface area, temperature and partial pressure of oxygen. The consumption of oxygen by this refractory should not be overlooked when choosing parameters. The best supporting material seemed to be the pre-oxidized test alloy itself, as mentioned above. Once oxidized, it is fairly stable to further oxidation and non-reactive with the test alloy to be oxidized.

The formed oxide layer is evident when viewed under light or electron microscopy and can be made substantially pore and crack free. The hardness of the oxide layer slowly decreases from the exterior surface of the coating towards the base metal or alloy, creating the gradual transition in the interface extending inwardly to the hardness of the base metal. This gradual transition in hardness in the interface is desirable, ensuring that an abrupt and undesirable change in elastic modulus is not seen. The surface hardness, as measured by nanoindentation, approximates that of pure zirconia (zirconium oxide), although increasing amounts of niobium in the base alloy can slightly lower the surface hardness. Lower levels of titanium preferentially used (<10% by weight) do not significantly affect the surface hardness. The zirconia phase is the stable monoclinic form as identified on X-ray diffraction. Niobium may be present as oxides or unoxidized form. This spectrographic phase distribution does not change after accelerated aging in an autoclave at 134° C. and 0.2 MPa for over 24 hours. Thus, the material has a stable crystalline structure. Beneath the outer oxide surface is the interface of oxygen enriched metal in which the hardness gradient continues to decrease gradually or transitionally towards that of the base metal. The interface thickness is proportional to the thickness of the oxide, but this ratio can also preferentially be modified by alloying metals, specifically those of niobium and titanium. As oxygen embrittles zirconium and zirconium-based alloys, deep penetration of oxygen into the base metal or alloy may not be desirable for many applications, and the interface to the base metal would preferentially be narrow, particularly in thinner sections of material, as the toughness and fracture resistance of the base metal or alloy is needed.

In support of the foregoing and as shown in FIG. 10, a hardness profile 1000 of an oxide coating of 75Zr20Nb5Ti by weight created in conjunction with the herein described process is depicted. More specifically, a specimen of the alloy material was heated in a furnace under vacuum at 20° C. per minute with oxidation at 1050° C. for 30 seconds under a partial pressure of 1.8 mbar of oxygen. The specimen was cooled under vacuum at 10° C. per minute to room temperature. As can be gleaned from this graphical representation, the hardness generally and gradually decreases with distance towards the base metal in a gradual manner.

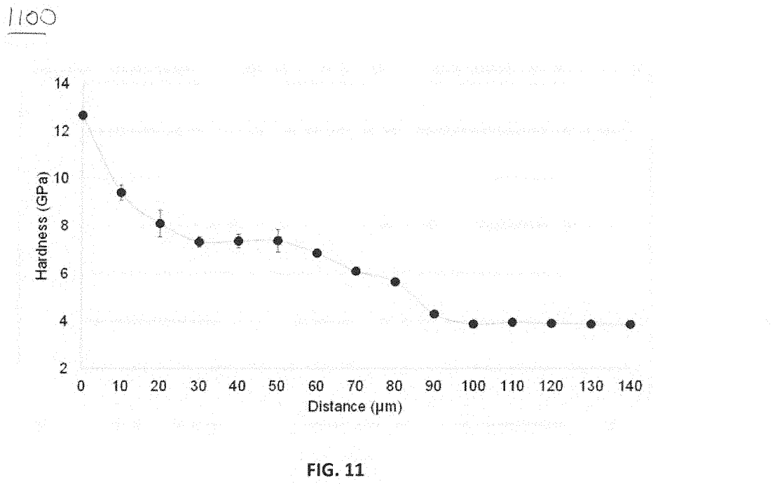

FIGS. 11-13 present additional hardness profiles of oxide coatings formed in accordance with the described herein process on various alloy samples. As in the prior example, each of the alloys described herein are based on weight percentages. More specifically, FIG. 11 represents a hardness profile 1100 of 55Zr40Nb5Ti also created in conjunction with aspects of the described process in which the specimen was heated in a furnace under vacuum at 20° C. per minute with oxidation at 1050° C. for 30 seconds under a partial pressure of 1.8 mbar oxygen. This specimen was cooled under low oxygen partial pressure at 1.8 mbar oxygen at 10° C. per minute to room temperature.

FIG. 12 presents a hardness profile 1200 of 75Zr20Nb5Ti also created according to aspects of the present invention. More specifically, this specimen was heated in a furnace under vacuum at 20° C. per minute with oxidation at 1050° C. for 30 seconds at partial pressure of 1.8 mbar oxygen. In this example, the specimen was cooled under a constant partial pressure of 1.8 mbar oxygen at 10° C. per minute to room temperature. As can be gleaned, the hardness profiles obtained for the same alloy (compare the profiles of FIGS. 10 and 12) can be tailored wherein the hardness gradually varies from the outer oxide layer towards the base metal in the interface.

In addition and as is known, zirconium is frequently found in nature combined with hafnium. Removal of the hafnium is expensive and typically performed for nuclear reactor use although many medical implants typically also utilize hafnium free zirconium alloy (e.g., ATI Wah Chang Zr2.5Nb). While hafnium-free zirconium may be preferred, at least for a number of uses, it has been determined that the inclusion of hafnium in small quantities does not adversely affect the creation of the oxide coating that is formed according to the process described herein.

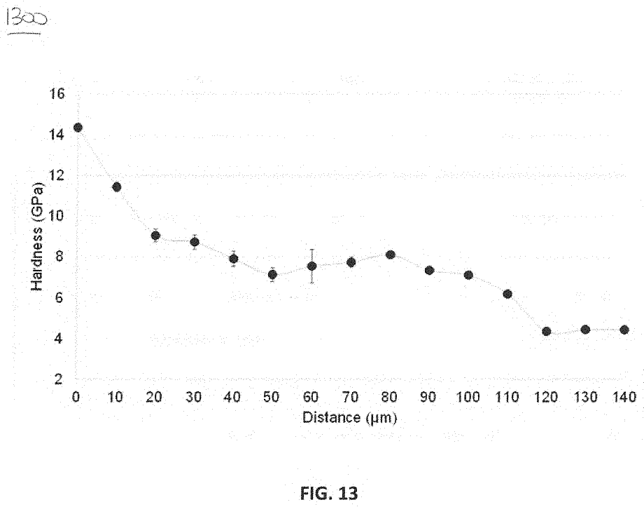

This is demonstrated according to the following example with reference to FIG. 13 which presents a hardness profile 1300 of 52.5Zr40Nb5Ti2.5Hf as created in accordance with the process of the present invention. In this example and like that of the prior example at FIG. 12, the alloyed specimen was heated under vacuum at 20° C. per minute with oxidation occurring at 1050° C. for 30 seconds at a partial pressure of 1.8 mbar of oxygen. The specimen was then cooled at a constant partial pressure of 1.8 mbar of oxygen at 10° C. per minute until room temperature had been reached. A comparison of the hardness profiles clearly indicates that the presence of hafnium does not impact the gradual transition in hardness from the outer formed layer to the base metal. In addition, it has been further determined that the mechanical properties of the resultant material are also not significantly impacted by inclusion of a zirconium having amounts of hafnium up to 4%. Accordingly, the inclusion or retention of hafnium in the zirconium base metal may be beneficial from a cost perspective without impacting the resultant oxide coating product, in accordance with the herein described process.

The fracture resistance of various alloys of zirconium was evaluated by 3 point bending to 45 degrees and measuring the depth of any cracks that formed in 5 mm thick specimens subject to the various oxidation process described herein. In a pure zirconium specimen (380 ppm oxygen content) oxidized to create a 16 micron oxide surface, 3 point bending to 45 degrees created an 800 micron crack depth (Crack to oxide ratio of 50 (C/0=50)). Subject to the same oxidizing conditions and bending, a sample of a widely commercially available alloy of 97.5Zr2.5Nb with 370 ppm oxygen content, an oxide of 14 microns and crack depth of 2600 microns was seen (C/0=185). Similarly, an oxide layer of 100 microns created on 75Zr20Nb5Ti by weight with 350 ppm oxygen content had a crack depth of 700 microns (C/O=7), 55Zr40Nb5Ti by weight and 390 ppm oxygen content, 100 micron oxide and 50 micron crack depth (C/0=1.5). As the percentage of niobium in the zirconium-based alloy is increased independent of oxygen concentration, the C/O ratio increases such that alloys of 90Zr10Nb, 80Zr20Nb and 60Zr40Nb will have oxides 20-30 microns thick, but C/O ratios >100 where the entire specimen cracked under bending. When titanium is added to ZrNb alloys with 15% or less niobium by weight, the addition allows for a thicker oxide under the same processing conditions, but does not usefully affect the C/O ratio until the niobium content is about 20% by weight. At this level of niobium and with the addition of small amounts of titanium (e.g. 1%), the C/O ratio starts to decrease. It has been determined that increasing the amount of titanium added to the alloy continues to lower the C/O ratio. The effect becomes maximal around 5% titanium and 40% niobium by weight in which the C/O ratio is approximately 1.5, as noted above.

In reference to the C/O ratio, the rate of cooling and amount of dissolved oxygen is an important factor. For example, if an alloy of 55Zr40Nb5Ti with 800 ppm oxygen content is oxidized to create an oxide layer of 50 microns and then cooled at 10° C. per minute, the C/O ratio will be >100. In contrast, if the same alloy with 800 ppm oxygen content is cooled at 50° C., the C/O ratio is about 20 and if air quenched, the C/O ratio is about 3. This is in stark comparison to the same alloy with 300 ppm oxygen content, in which the mechanical properties and C/O ratio are relatively insensitive to the rate of cooling with the C/O ratio varying between 1.5 and 4.

While the herein described oxide forming process will work for pure zirconium and certain zirconium-based alloys, the pure metal and certain zirconium-based alloys will generally not allow the creation of a crack-free oxide coating on a sharp or curved edge or an outside corner radius. However, it has been determined that preferably alloying with niobium and/or titanium has been shown to optimize the process such that even sharp edges and corners can be oxidized in accordance with the herein described process without cracking. As previously discussed, one preferred alloy (by weight percentage) is 55% zirconium, 40% niobium, 5% titanium. This specific combination creates an alloy with a thick hard oxide layer that is tenaciously attached to the base metal substrate and overlies a relatively thin interface that transitions to the base metal, thus retaining the ductility and toughness of the base metal. It will be understood, from the foregoing discussion that other amounts of alloying elements can be added, depending upon the intended use or application, which may include molybdenum, tungsten, tantalum, for example.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. Therefore, to the extent there are variations of the invention, which are within the spirit of the disclosure or equivalent to the inventions found in the claims, it is the intent that this patent will cover those variations as well.

To the extent that the claims recite the phrase “at least one of” in reference to a plurality of elements, this is intended to mean at least one or more of the listed elements, and is not limited to at least one of each element. For example, “at least one of an element A, element B, and element C,” is intended to indicate element A alone, or element B alone, or element C alone, or any combination thereof. “At least one of element A, element B, and element C” is not intended to be limited to at least one of an element A, at least one of an element B, and at least one of an element C.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated and in accordance with the following appended claims. Additional embodiments include any one of the embodiments described above and described in any and all exhibits and other materials submitted herewith, where one or more of its components, functionalities or structures is interchanged with, replaced by or augmented by one or more of the components, functionalities or structures of a different embodiment described above.

### PARTS LIST FOR FIGS. 1-14

102 arrow
104 arrow
106 arrow
202 arrow
204 arrow
302 arrow
304 arrow
306 arrow
307 layer, transitional interface
308 layer, metal core
309 layer, oxide coating
402 crack
502 crack
702 delaminated layer
802 delaminated layer
900 oxide forming process
902 step
904 step
906 step
908 step
1000 hardness profile
1100 hardness profile
1200 hardness profile
1300 hardness profile

This detailed description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. As noted, it will be understood that other suitable variations and modifications will be readily apparent and understood by those of sufficient skill in the field reading the preceding detailed description and as will further be understood from the following listed claims.

I claim:

1. A process for forming an oxide or oxide-like coating on zirconium metal or zirconium-based alloys, the process comprising the steps of:
heating the metal or alloy in a furnace either rapidly to a predetermined temperature in an oxidizing or non-oxidizing environment or heating the metal or alloy to a temperature in an environment substantially devoid of an oxidizing agent until the predetermined temperature has been reached before subjecting the metal or alloy to the oxidizing environment.

2. The process according to claim 1, including the step of controlling the hardness and toughness of the oxide or oxide-like coating based on one or more oxidation-related parameters.

3. The process according to claim 2, wherein the one or more oxidation—related parameters comprise at least one of alloy composition in the instance of a zirconium based alloy, and cooling the heated metal or alloy either under vacuum or in the presence of oxygen.

4. The process according to claim 1, including the step of controlling the ratio of crack depth to oxide depth (C/O ratio) by at least one of alloy selection, the amount of at least one alloy in the zirconium-based alloy, oxygen content in the zirconium-based alloy, and a rate of cooling of the heated metal or alloy.

5. The process according to claim 1, in which the predetermined temperature is at least 800° C.

6. The process according to claim 1, wherein the predetermined temperature is at least 900° C.

7. The process according to claim 1, wherein the predetermined temperature is at least 1000° C.

8. The process according to claim 1, wherein the oxidizing agent is oxygen and further comprising the step of heating the metal or alloy under vacuum until the predetermined temperature is reached.

9. The process according to claim 1, wherein the zirconium based alloy includes at least one of niobium and titanium.

10. The process according to claim 9, wherein the zirconium based alloy contains at least 10 percent niobium by weight.

11. The process according to claim 9, wherein the zirconium based alloy contains at least 20 percent niobium by weight.

12. The process according to claim 9, wherein the zirconium based alloy contains about 40 percent niobium by weight.

13. The process according to claim 9, wherein the zirconium based alloy contains no more than 15 percent titanium by weight.

14. The process according to claim 9, wherein the zirconium based alloy contains about 5 percent titanium by weight.

15. The process according to claim 9, wherein the zirconium based alloy contains 55 percent zirconium, 40 percent niobium and 5 percent titanium by weight.

16. The process according to claim 9, wherein the zirconium based alloy contains 75 percent zirconium, 20 percent niobium and 5 percent titanium by weight.

17. The process according to claim 1, further comprising a cooling step following the heating step.

18. The process according to claim 17, wherein the cooling step is conducted in the presence of the oxidizing agent.

19. The process according to claim 18, wherein the oxidizing agent is oxygen and in which the cooling step further comprises controlling the partial pressure of the oxygen, the oxidation temperature and an exposure time thereof in order to adjust the thickness and hardness of the formed oxide.

20. The process according to claim 1, in which the zirconium or zirconium based alloy includes amounts of hafnium.

21. An oxide coating for a zirconium metal or a zirconium-based alloy made by a process in which the zirconium metal or a zirconium-based alloy is one of rapidly heated in a furnace to a predetermined temperature in an oxidizing or non-oxidizing environment or slow or rapidly heated in the furnace, which is substantially devoid of an oxidizing agent until the furnace has reached the predetermined temperature.

22. The oxide coating according to claim 21, wherein the oxidizing agent is oxygen and in which the process further includes applying a vacuum to the furnace or filling the furnace with an inert gas at sub-atmospheric, atmospheric or supra-atmospheric levels until the temperature has reached the predetermined temperature.

23. The oxide coating according to claim 21, in which the predetermined temperature is at least 800° C.

24. The oxide coating according to claim 21, in which the zirconium-based alloy can include at least one of niobium and titanium.

25. The oxide coating according to claim 21, in which the process further includes cooling the metal or alloy in the presence of the oxidizing agent.

26. The oxide coating according to claim 25, wherein the oxidizing agent is oxygen and the process includes controlling the partial pressure of oxygen in the furnace during the cooling step in order to adjust the thickness of the formed oxide layer.

27. The oxide coating according to claim 24, in which the zirconium-based alloy contains no more than 15 percent titanium and about 40 percent niobium by weight.

28. The oxide coating according to claim 27, in which the zirconium based alloy contains 55 percent by weight of zirconium, 40 percent by weight of niobium and 5 percent by weight of titanium.

29. The oxide coating according to claim 27, in which the zirconium based alloy contains 75 percent zirconium, 20 percent niobium and 5 percent titanium by weight.

30. A system for producing an oxide coating for zirconium metal or a zirconium based alloy, the system comprising a furnace having a vacuum pump to control the partial pressure of an oxidizing gas wherein the system is configured to substantially maintain vacuum within the furnace until the furnace has reached a predetermined oxidizing temperature.

31. A system for producing an oxide coating for zirconium metal or a zirconium based alloy, the system comprising a furnace having a vacuum pump to control the partial pressure of an oxidizing gas to allow chamber backfill with an inert gas wherein the system is configured to substantially maintain a low oxidizing potential within the furnace until the furnace has reached a predetermined oxidizing temperature.

32. The system according to claim 30, wherein the predetermined temperature is at least 800° C., more preferably at least 900° C., and still more preferably at least 1000° C.
